(19) United States
(12) Patent Application Publication
(10) Pub. No.: US 2012/0329022 A1
(43) Pub. Date: Dec. 27, 2012

(54) CHEST COMPRESSION TRAINING ASSEMBLY

(76) Inventors: Eirik Hetland, Stavanger (NO); Domenico Livio Francese, Stavanger (NO)

(21) Appl. No.: 13/169,319

(22) Filed: Jun. 27, 2011

(51) Int. Cl. G09B 23/28

(52) U.S. Cl. 434/265

(57) ABSTRACT

A chest compression training assembly comprising an upper portion and a lower portion, wherein the upper portion is adapted to be moved towards the lower portion when a compression force is exerted on the upper portion, and to move back to a noncompressed position when the compression force is removed. An upper element is connected to the upper portion and a lower element is connected to the lower portion, wherein the upper and lower elements both contain a magnetic material and are facing each other. At least one of the upper and lower element comprises a magnet. At least one of the upper and lower element is arranged on an element retainer permitting the upper or lower element to move within a predetermined path towards the facing upper or lower element. The upper and lower element are arranged in such way that one may be moved into a certain proximity of the other during a compression movement of the top of the assembly. Magnetic attraction between the upper and lower elements results in acceleration, within said path, of one of the upper and lower elements towards the other when in said proximity, wherein said acceleration results in a collision which produces an audible sound.

The present invention relates in general to a chest compression training assembly and more particularly to a magnetic clicker assembly for producing an audible feedback during the training of chest compression.

### TECHNICAL FIELD

Medical procedures like Cardio Pulmonary Resuscitation (CPR) needs sufficient theoretical knowledge as well as practical training for complete learning. More importantly students require substantial practical training to expertise in these procedures.

Manikins are used for training individuals to perform the procedure of mouth-to-mouth artificial respiration and closed chest heart massage, for performing cardiopulmonary resuscitation training or CPR, and for instruction in rescue breathing where heart failure is not a factor.

In order to provide medical rescue training like CPR or heart massage, manikins and other training apparatuses must simulate human body responses as in a real situation. Further, many complex and interrelated functions are also required to be simulated by a training manikin.

Much research has been done to improve training manikins with proper feedback mechanisms for training of students. It has always been a need to incorporate simple cost effective feedback devices in manikins which are easy to design but still are efficient in their operation as an improved simulated training apparatus. The feed back system is required for the students to understand the correctness of the simulated procedure being carried out by them, which is essential knowledge in a real situation.

For example during CPR, chest compression is required for heart message. Such compression should be carried out with a predetermined pressure and depth. So in a training manikin or assembly there is an inherent need for an audible feedback mechanism to indicate the correctness of the desired chest compression during CPR.

Several such feedback systems have been worked upon to achieve such objective. Electromechanical transducers have been used in different forms as a solution to produce such feed back. But these electronic means are expensive and may malfunction. Thus there remains a requirement to design a simple functioning, cost effective, mechanical solution which will still be efficient in its operation and easy to incorporate in a simulation training manikin or assembly.

Mechanical solutions for producing audible feedback such as mechanical metal clickers produce two sounds such as clicks, one during activation of the clicking device and another during deactivation. Such plurality of sound is undesired.

An example of such mechanical clicker device is disclosed in US 20010012609 which uses a clicker pin to produce audible feedback. US 20070292828 discloses a sound generating assembly which incorporates a pressure activated means which can be electrical or mechanical like clicker or whistle but still the problem of more than one sound remains unsolved in the state of art.

The present invention aims to offer a simple solution by providing a novel magnetic clicker assembly to overcome such disadvantage of the prior art.

### OBJECT

The primary of object of the present invention is to provide a clicker assembly which produces only one single audible feed back during a cycle of compression and decompression of a manikin body part or a chest compression training assembly.

It is another object of the present invention is to provide a clicker assembly for a training manikin or assembly having simple mechanical audible feed back means and which is cost effective.

### THE INVENTION

According to the present invention, there is provided a chest compression training assembly comprising an upper portion and a base portion. The upper portion is adapted to be moved towards the base portion when a compression force is exerted on the upper portion, and to move back to a non-compressed position when the compression force is removed. An upper element is connected to the upper portion and a lower element is connected to the lower portion. The upper and lower elements both contain a magnetic material and are facing each other. At least one of the upper and lower element comprises a magnet. At least one of the upper and lower elements is arranged on an element retainer permitting the upper or lower element to move within a predetermined path towards the facing upper or lower element. The upper and lower elements are arranged in such way that one may be moved into a certain proximity of the other during a compression movement of the top of the assembly. Magnetic attraction between the upper and lower elements results in acceleration, within said path, of one of the upper and lower elements towards the other when in said proximity. The acceleration results in a collision which produces an audible sound.

With such a chest compression training assembly, a collision is provided, for instance between the upper and lower element, which will result in an audible sound during the compression movement. That is, at a correct compression distance, the upper and lower element will be so close to each other that magnetic attraction between the two will make at least one of them accelerate into a collision. When hearing the sound of the collision, the user will know that he has reached the correct compression depth of the chest (i.e. the upper portion).

In one embodiment, the element retainer retains the lower element and exhibits a soft surface, so that when the lower element moves downwards after being pulled off its contact with the upper element during an upward movement of the upper portion, it is received by the retainer in a noiseless manner. Preferably, gravity will pull the lower element back into a lower position. Thus, when falling back down into the lower position, a soft surface will ensure that this does not produce an audible sound. During one complete cycle of compression and decompression of the chest, or upper portion of the assembly, only the compression will result in an audible sound.

In one embodiment the element retainer comprises a through hole extending in the direction of the upper element. The lower element is connected to the upper end of a bar which extends through the through hole and which is longer than the extension of the through hole. Furthermore, a lower portion of the bar is provided with halting means adapted to limit the upper possible position of the bar and lower element. This function is provided by adapting the halting means to collide with a colliding face.

The chest compression training assembly may be arranged with a manikin resembling a human body or human torso.

In a further embodiment, the magnet is a non-permanent magnet controlled by delivery of current to inductive windings. In such an embodiment, the magnet can be adapted to be turned on and off by control of current delivered to the magnet.

The lower element can be connected to a sliding holder which is adapted to be slid between a position in which the lower element faces the upper element, and a position in which the lower element does not face the upper element. In this way, the user may turn the sound-making function on and off manually by moving the lower element into or out of the functioning position.

### EXAMPLE OF EMBODIMENT

While the invention has been outlined above, a more detailed example of embodiment is given below with reference to the drawings, in which

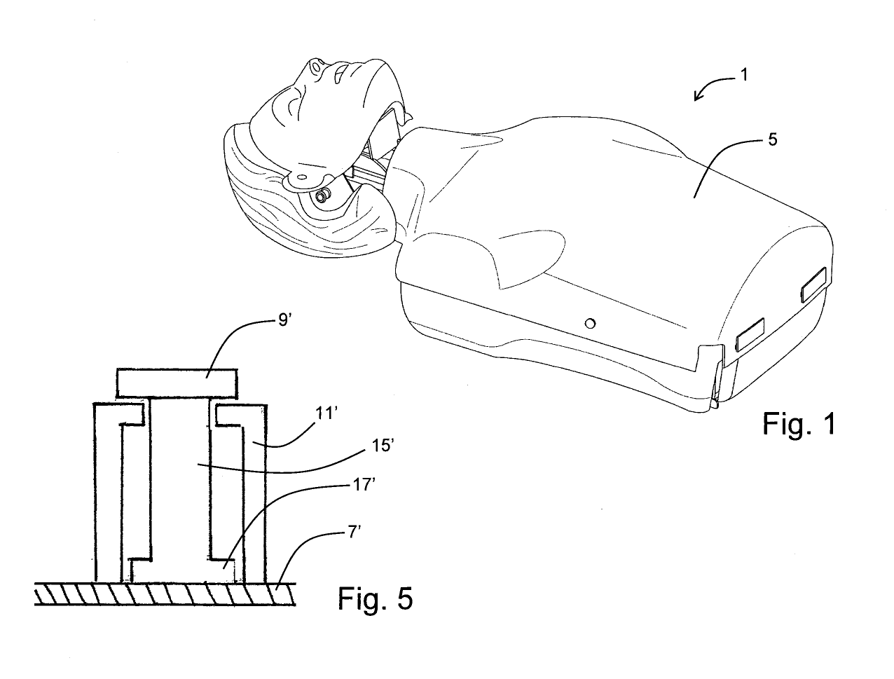

FIG. 1 is a perspective view of a manikin resembling a human torso, within which a chest compression training assembly according to the invention can be arranged;

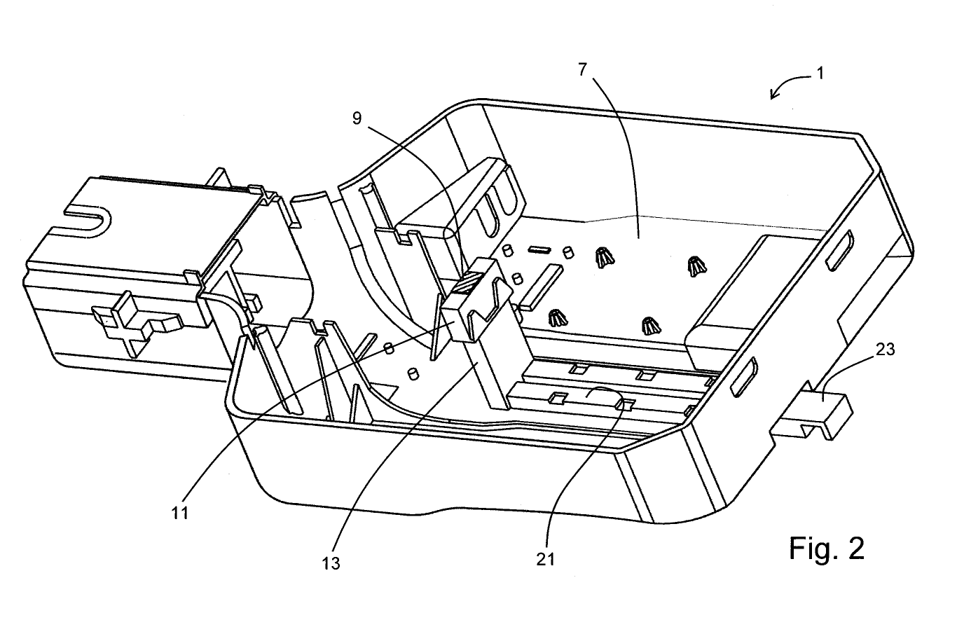

FIG. 2 is a perspective view of the manikin shown in FIG. 1, however with some parts removed in order to illustrate the inside of the manikin, such as a lower element;

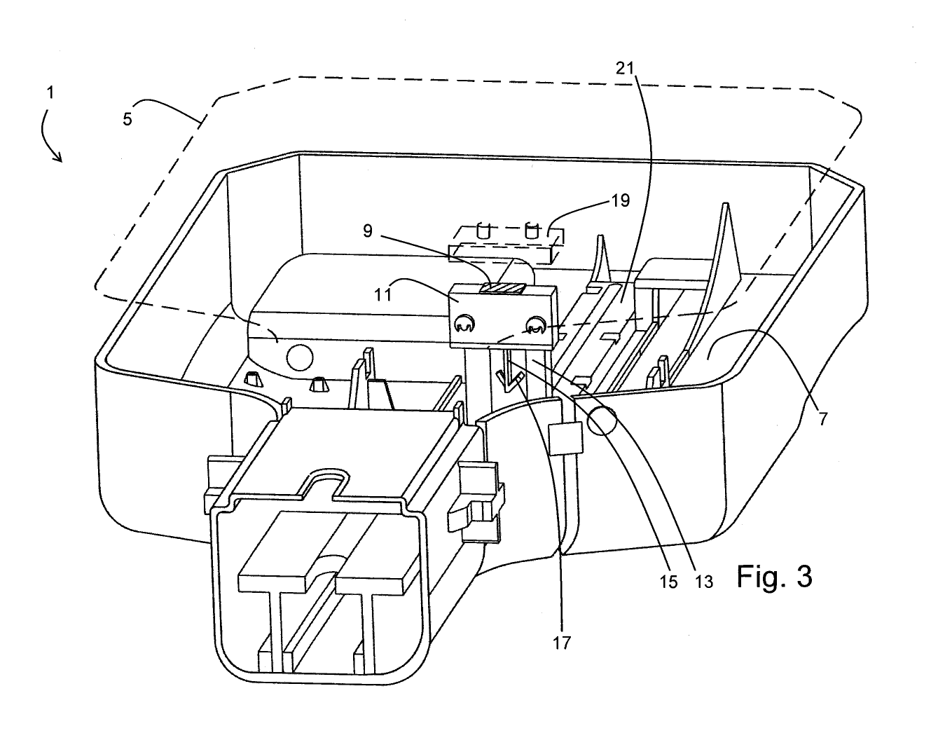

FIG. 3 is another perspective view of the torso, in which also the upper element is indicated and having a distance to the lower element;

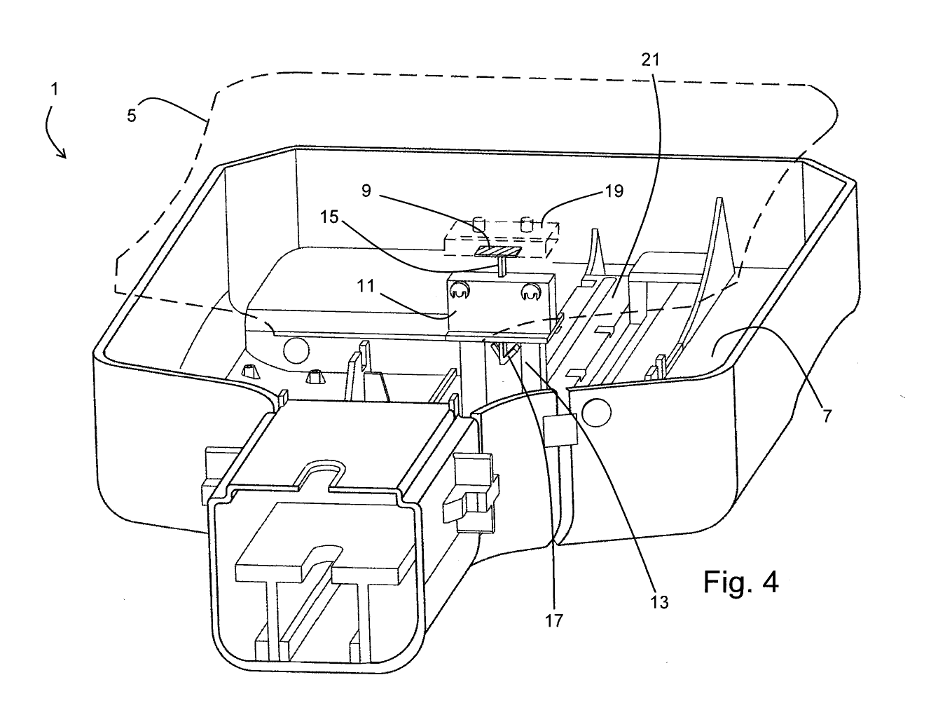

FIG. 4 is a perspective view as in FIG. 3, however showing the lower element having collided with the upper element and still being in contact with the upper element; and

FIG. 5 is a schematic view illustrating an alternative embodiment.

The present invention will now be described in detail with reference to the accompanying drawings. All through the specification including the claims, the words ‘manikin’, ‘magnet’, ‘clicker’, ‘magnetic material’, ‘CPR’ are to be interpreted in the broadest sense of the respective terms and includes all similar items in the field known by other terms, as may be clear to persons skilled in the art. Restriction/limitation, if any, referred to in the specification, is solely by way of example and understanding the present invention.

Referring to FIG. 1, the manikin 1 may be of suitable size resembling a child or an adult. The manikin may also have the other design features such as head, mouth, nose and airway passages simulating actual movement of those body parts during CPR operation. The torso simulation area has an upper portion 5 resembling the chest part and a lower portion 7 (FIG. 2) resembling the back part.

The upper portion 5 or chest part of the torso can be made of flexible sheet material which is compressible to simulate a realistic chest compression required for teaching and practicing.

According to the object of this invention, whenever a person compresses the chest portion, it should give a single audible feedback e.g. a clicking sound whenever the predetermined depth is reached by suitable compression in order to confirm right compression procedure.

FIG. 2 shows the torso 1 without the upper portion 5. In this drawing one can see the lower element 9 resting on an element retainer 11 which is supported on the lower portion 7. An arm 13 holds the element retainer 11 in an elevated position above the lower portion 7.

FIG. 3 shows the lower element 9 and the element retainer 11 from another angle. In this drawing one can also see a bar 15 that extends out from a lower side of the element retainer 11. The bar 15 extends through a vertical through hole in the element retainer 11, to an upper side of the element retainer 11. At the upper end of the bar 15 the lower element 9 is attached. In the position shown in FIG. 3, the lower element 9 has a lower position and rests on the upper face of the element retainer 11.

At the lower end of the bar 15, the bar 15 is provided with halting means in the form of two hooks 17 that will abut against the lower side of the element retainer 11 if the bar 15 and lower element 9 is moved upwards into an upper position. Such an upper position is shown in FIG. 4.

FIG. 4 shows the upper element 19 which is attached to the upper portion 5 of the torso 1 (indicated with dashed line). Both the upper element 19 and the lower element 9 are made of a magnetic material, such as iron. In this embodiment the upper element 19 is a permanent magnet. One can however also imagine that one of the elements, for instance the upper element 19, is a non-permanent magnet which needs current delivered to its windings in order to function as a magnet.

When the upper portion 5 is compressed, that is moved downwards by the user practising CPR, the upper element 19 will be moved into a certain proximity of the lower element 9 when the user has reached a required compression distance. When in this proximity, the magnetic attraction between the upper element 19, being a permanent magnet, and the lower element 9, will provide an acceleration of the lower element 9 in the upwards direction towards the facing upper element 19. The acceleration will result in such a velocity of the lower element 9 that an audible sound will result from the collision of the lower element 9 on the upper element 19.

Then, when the user removes the compression force, the elasticity of the upper portion 5 of the torso 1 will pull the upper element 19 back upwards. The contact between the lower element 9 and the upper element 19 will remain until the upper element 19 is pulled off the lower element 9. When the contact is lost and the upper element 19 is moved out of the said proximity of the lower element 9, the lower element 9 will fall back onto the element retainer 11.

In this embodiment, the element retainer 11 is made of a foam material. This choice of material results in a soundless fall of the lower element 9 onto the element retainer 11.

It should be noted that when the clicking sound has occurred, there is still room for additional compression.

In one embodiment, the lower element may be adjusted vertically by adjusting its position on the arm 13 extending up from the lower portion 7. In this manner a training instructor may adjust the correct compression depth.

Referring again to FIG. 2. On the lower portion 7 of the torso 1 there is arranged a guiding rail 21. The arm 13, which carries the element retainer 11, is arranged to the guiding rail 21 in a sliding manner. That is, with a handle 23, which extends out from the torso, the user may slide the arm 13 along the guiding rail 21. In this manner, the user can move the lower element 9 out of its functioning position. Such a position will be one in which the upper element 19 will not make the magnetic attraction accelerate the lower element into a movement in which it collides with the upper element.

FIG. 5 schematically illustrates an alternative embodiment of the lower element 9′ and the element retainer 11′. Here, the lower portion 7′ can advantageously have a soft surface, or the lower end of the bar 15′ may have a downwardly facing soft surface, in order to avoid sound when falling onto the lower portion 7′.

One may also imagine that instead of having the colliding lower element 9, 9′ and upper element 19 making the audible sound, the sound may be produced by other colliding parts. For instance, the collision of the hooks 17, 17′ with a downwardly facing surface of the element retainer 11, 11′ may produce such an audible sound. This may also occur without the upper element 19 and the lower element 9, 9′ ever colliding with each other.

This concept of producing a single audible feedback is primarily based on the concept that the magnet or oppositely arranged magnetic material element can accelerate and move to collide on a part of the other clicker device to make a sound when the chest is compressed and then be pulled silently off when the chest is decompressed.

The inventive concept is useful in operating the training manikin for teaching of correct procedure of chest compression for CPR purposes.

Thus the inventive concept offers a simple solution to the confusing multiplicity of sound associated with normal clicker assembly during compression and decompression of a manikin surface. The complex designing problem of the prior art clicker assembly can be avoided and substantial cost reduction may be achieved.

The invention has been described with the help of an embodiment as described above. It can be modified further without departing from the scope of the invention as described above and defined in the appended set of claims.

1. A chest compression training assembly comprising an upper portion and a lower portion, wherein the upper portion is adapted to be moved towards the lower portion when a compression force is exerted on the upper portion, and to move back to a non-compressed position when the compression force is removed, wherein
an upper element is connected to the upper portion and a lower element is connected to the lower portion, wherein the upper and lower elements both contain a magnetic material and are facing each other;
at least one of the upper and lower element comprises a magnet;
at least one of the upper and lower element is arranged on an element retainer permitting the upper or lower element to move within a predetermined path towards the facing upper or lower element;
said upper and lower element are arranged in such way that one may be moved into a certain proximity of the other during a compression movement of the top of the assembly;
magnetic attraction between the upper and lower elements results in acceleration, within said path, of one of the upper and lower elements towards the other when in said proximity, wherein said acceleration results in a collision which produces an audible sound.

2. A chest compression training assembly according to claim 1, wherein the element retainer retains the lower element and exhibits a soft surface, so that when the lower element moves downwards after being pulled off its contact with the upper element during an upward movement of the upper portion, it is received by the retainer in a noiseless manner.

3. A chest compression training assembly according to claim 2, wherein the element retainer comprises a through hole extending in the direction of the upper element, wherein the lower element is connected to the upper end of a bar which extends through the through hole and which is longer than the extension of the through hole, wherein a lower portion of the bar is provided with halting means adapted to limit the upper position of the bar and lower element, the halting means being adapted to collide with a colliding face.

4. A chest compression training assembly according to claim 1, wherein it is arranged with a manikin.

5. A chest compression training assembly according to claim 1, wherein said magnet is a non-permanent magnet controlled by delivery of current to inductive windings.

6. A chest compression training assembly according to claim 5, wherein the magnet is adapted to be turned on and off by control of current delivered to the magnet.

7. A chest compression training assembly according to claim 1, wherein the lower element is connected to a sliding holder which is adapted to be slid between a position in which the lower element faces the upper element, and a position in which the lower element does not face the upper element.
